(19) United States
(12) Patent Application Publication
(10) Pub. No.: US 2007/0299881 A1
(43) Pub. Date: Dec. 27, 2007

(54) SYSTEM AND METHOD FOR PROTECTING SELECTED FIELDS IN DATABASE FILES

(76) Inventor: Shimon Bouganim, Rishon Letzion (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 11/616,913

(22) Filed: Dec. 28, 2006

Related U.S. Application Data
(60) Provisional application No. 60/805,367, filed on Jun. 21, 2006.

(51) Int. Cl. G06F 17/30

(52) U.S. Cl. 707/200

(57) ABSTRACT

A system and method for masking selected information in at least one original Db file to prevent unauthorized access to that information, the at least one original Db file being duplicated from a Private Zone having full accessibility thereto, into a Public Zone having only partial accessibility thereto, the system comprising Mask Definition, Activation, and Synchronization segments operating together and in conjunction with a File Protection segment to make at least one duplicate Db file corresponding to an original Db file, in order to prevent unauthorized access to the original data, wherein the at least one duplicate Db file is masked against unauthorized access by having sensitive fields masked, and wherein both the at least one duplicate and the corresponding original Db files are disposed in the Public Zone and the Private Zone, respectively, comprising a Field Masking System for sensitive file and field protection.

### FIELD OF THE INVENTION

The present invention generally relates to the field of computer information security and data protection via data masking, and more particularly, to a software system and a method for masking selected database files at the level of fields.

### BACKGROUND

Increasing demands upon corporate bodies to tighten up controls over who can access sensitive data has created a growing need for tools for this purpose. Today, there are a variety of technologies to help achieve this, some from the various creators of computer operating systems, and others from independent, enterprise solution providers. Currently, however, there are no specifically designed software solutions for preventing access by some users to sensitive files and/or fields, while allowing access by others to these same files and/or fields. It is clearly not found in proprietary programs, such as IBM's iSeries (OS/400 or i5/OS) operating system, nor is it available in third party software.

Therefore it would be desirable to provide a system which will overcome the drawbacks of the prior art and provide a solution to the problem of preventing access by some users to sensitive files and/or fields, while allowing access by others.

### Glossary

Unless otherwise indicated, the following terms are used in the present application with the specific meaning as indicated in the Explanation column:

| Term | Explanation |
|---|---|
| Data field | Data field in a database (Db) file, for |
| | example, an iSeries Db field |
| Masking | Process to prevent viewing sensitive |
| | values in a data field |
| Power User | A user who has access to all files, |
| | from the point of view of the |
| | operating system authorities |
| Operating System | In a preferred embodiment of the |
| | invention, an IBM OS/400 or |
| | i5/OS, unless otherwise noted |
| Private Zone | Description of the logical |
| | area of a database having files |
| | containing unmasked, readable field |
| | values fully accessible only |
| | to authorized (private) users |
| Public Zone | Description of the logical area of a |
| | database having a duplicate |
| | file of an original from the Private Zone, |
| | but with selected masked |
| | or replaced field values. The files |
| | residing in the Public Zone are |
| | accessible to the mainstream of users |

### SUMMARY OF THE INVENTION

Accordingly, it is a broad object of the present invention to overcome the disadvantages and limitations of the prior art by providing a system and a method for preventing access by most users to sensitive fields, while allowing access only to authorized users.

In a preferred embodiment of the invention, and by way of example, the system and method described herein are applied to IBM's midrange family of computers, comprising AS/400, iSeries, i5 and System i models, under the OS/400 or i5/OS operating systems, but the concept of using the same or similar masking processes to protect sensitive data and fields as explained hereinafter, is not limited to only one operating system and can be applied across other operating platforms as well, as is known to those skilled in the art.

Therefore, there is provided a system for masking at least one selected field in at least one, original Db file, the system comprising:

a) a Mask Definition means for defining the at least one, selected field for activation of masking;

b) an Activation means for implementing the masking by creating at least one duplicate file of a corresponding one of the at least one, original Db file, and masking the at least one, selected field therein; and

c) a Synchronization means for synchronizing data between the at least one, original Db file and a corresponding one of the at least one duplicate file,

such that when a user has defined the at least one, selected field for masking utilizing the Mask Definition means, and has implemented the masking utilizing the Activation means, the Synchronization means synchronizes data between the at least one duplicate file and a corresponding one of the original Db file.

There is also provided a method for masking at least one, selected field in at least one, original Db file, the method comprising:

a) defining the at least one, selected field for activation of masking;

b) implementing the masking by creating at least one duplicate file of a corresponding one of the at least one, original Db file, and masking the at least one, selected field therein; and

c) synchronizing data between the at least one, original Db file and a corresponding one of the at least one duplicate file,

such that when a user applies a definition from step a) to the at least one, selected field and has implemented the masking, the data is synchronized between the at least one duplicate file and a corresponding one of the at least one, original Db file.

The original Db file is duplicated from a Private Zone (see Glossary) having full accessibility to the selected information, to a duplicate Db file in a Public Zone (see Glossary) having only partial accessibility to the duplicated selected information due to controlled masking of selected fields in the duplicated Db file.

The method for mask definition comprises the steps of: selecting files for masking; selecting fields for masking; selecting a mode of synchronization between the Private Zone file and the corresponding Public Zone file, the mode being selected from the group comprising: none, one-way, and two-way; and selecting a masking algorithm for a field from the group comprising: high values, low values, encrypted, all 9's, all zeros, and blanks.

Masking, in the context of the present invention, means blocking the actual values of the selected field from any unauthorized user who attempts to gain access to it. It is implemented by physically changing the value of the field with a ‘mask value’ in accordance with the masking algorithm selected.

The masking process is facilitated, following definition and subsequent activation, through the creation of a second file or table, parallel to the original. The original file containing all the original field values and continues to reside in its original library (as in, for example, the IBM OS/400 system). It is considered to be in the Private Zone and hence is termed a Private Zone file. The duplicated file, with selected masked or replaced field values, resides in the Public Zone and hence is termed a Public Zone file. It is placed in a different library.

Once the Public Zone file has been created by the activation process, access to the Private Zone file may and should be prevented. A further, complementary, process is enabled using a File Protection means. The Public Zone file then remains accessible to the mainstream of users, whereas the Private Zone file will be accessible only to those authorized by the system. These access restrictions cannot be bypassed by making use of the operating system's access control facility (for example, object authority in the OS/400 system). The invention therefore implements the File Protection means in such as way as to be secure against any user, even power users with the highest level of operating system authority.

Other features and advantages of the invention will become apparent from the following drawings and descriptions.

### BRIEF DESCRIPTION OF THE DRAWINGS

For a better understanding of the invention in regard to the embodiments thereof, reference is made to the following drawings, in which like numerals and letters designate corresponding sections or objects throughout, and in which:

FIG. 1 is a conceptual diagram showing Private and Public Zones and the Private/Public Field Protection system in accordance with a preferred embodiment of the present invention;

FIG. 2 is a content diagram showing input and output, both internal and external of the Field Masking system in a preferred embodiment of the present invention.

FIG. 3 is a data flow diagram, showing the interaction between the vital process segments comprising the Field Masking System in a preferred embodiment of the present invention;

FIG. 4 is a data flow diagram showing in detail the data flow process of the Synchronization segment;

FIG. 5 is a flow chart of the method of the Mask Definition process segment;

FIG. 6a is a flow chart showing the starting masking actions of the Activation method;

FIG. 6b is a flow chart of the ending masking actions of the Activation method;

FIG. 7 is a flow chart of the method of the Synchronization process segment; and

FIG. 8 is a flow chart of the method of the File Protection process segment.

### DETAILED DESCRIPTION OF THE PREFERRED EMBODIMENTS

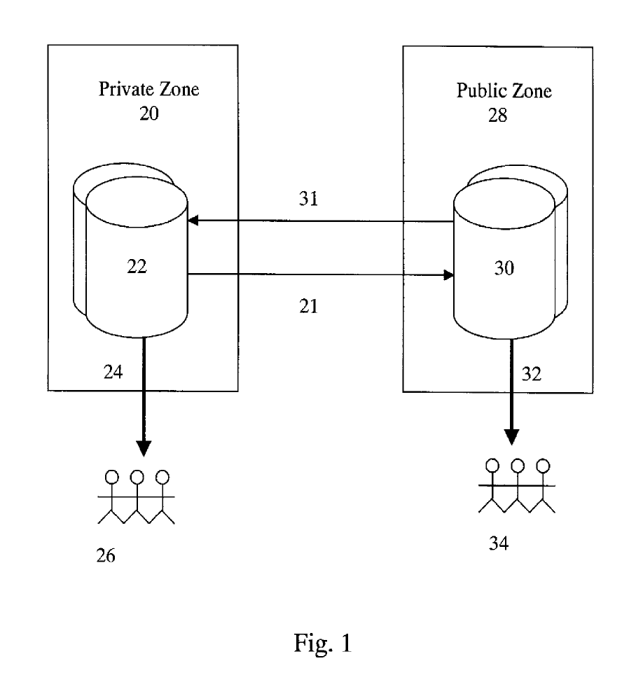

FIG. 1 is a conceptual diagram showing Private and Public Zones and the Field Masking System in accordance with a preferred embodiment of the present invention.

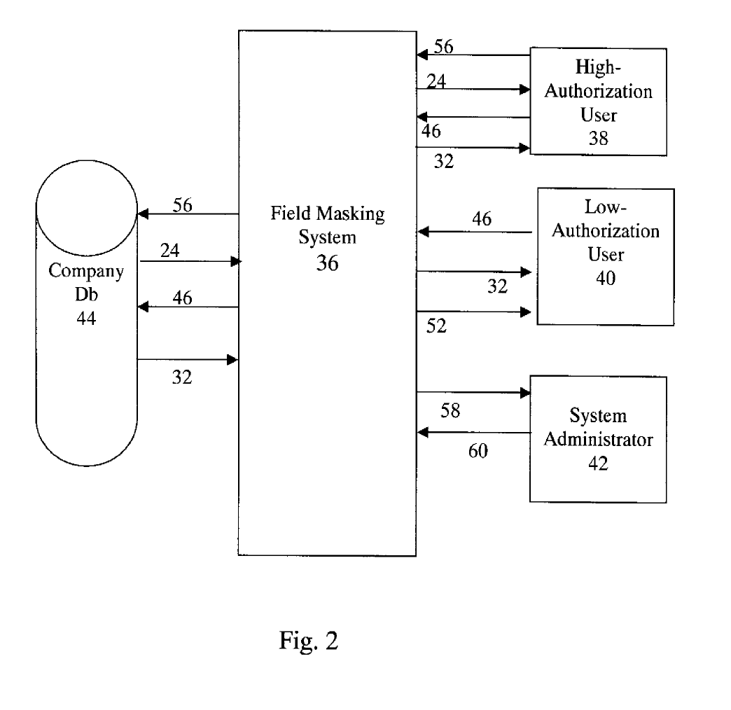

The Private Zone 20 is defined as one which contains at least one Db 22 representing original, unmasked, readable files having sensitive field values which are only accessible to the at least one authorized user 26, as indicated by the arrow representing the flow of sensitive field details 24. When the Field Masking System 36 (see FIG. 2) of the invention is implemented, original, select data from at least one Db 22 is copied into at least one Db 30 disposed in Public Zone 28, but with sensitive field details 24 masked.

Only the flow of non-sensitive field details 32, shown by an arrow, is accessible to the at least one public user 34.

The corresponding Db 22 and Db 30 are kept updated with one another in accordance with optional synchronization steps as explained hereinafter. Synchronized private data 21 flows into Db 30 in Public Zone 28, whereas synchronized public data 31 flows into Db 22 in Private Zone 20, the synchronization flow being controlled in accordance with company policy.

FIG. 2 is a content diagram showing input and output, both internal and external of the Field Masking System, in a preferred embodiment of the present invention. A Field Masking System 36 for masking at least one sensitive field is the central point for interaction with three levels of users: a High-authorization user 38, a Low-authorization user 40, and a System Administrator 42 in relation to input and output from data in a Company Db, such as Db 44.

There are two kinds of output from Company Db 44: Sensitive field details 24 and Non-sensitive field details 32.

Company Db 44 also receives input of Sensitive field updates 56 and Non-sensitive field updates 46 from High-authorization user 38. Low-authorization user 40 generates Non-sensitive field updates 46 to Company Db 44.

A High-authorization user 38 has full access to update Db 44 with both Sensitive field updates 56 and Non-sensitive field updates 46 and to access the database with Sensitive field details 24 and Non-sensitive field details 32 through Field Masking System 36.

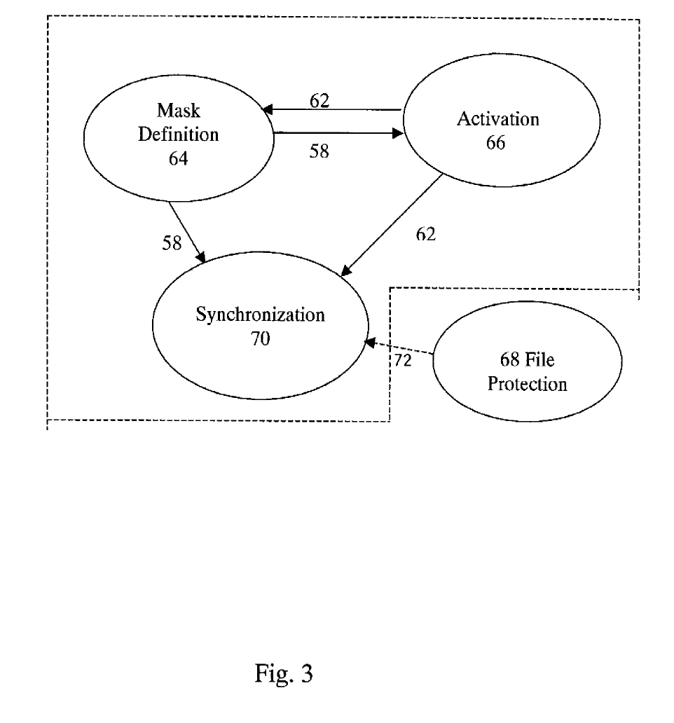

A Low-authorization user 40, on the other hand, can input Non-sensitive field updates 46 to Db 44 via Field Masking System 36, and download Non-sensitive field details 32, but if Low-authorization User 40 attempts to access any unmasked, original file with sensitive data from the Private Zone (see FIG. 1), the system responds by sending only an Access Denial message 52 due to the intervention of the File Protection segment 68 (see FIG. 3) of Field Masking System 36.

The System Administrator 42 has managerial control over the system, entering mask definition details 60 to Field Masking System 36 and receiving Details of Mask Definition Outputs 58 from Field Masking System 36.

FIG. 3 is a data flow diagram, showing the interaction between the process segments comprising the Field Masking System in a preferred embodiment of the present invention.

A Mask Definition segment 64 and an Activation segment 66 both interact with a Synchronization segment 70, in accordance with a preferred embodiment of the present invention. Activation segment 66 provides Masking Activation Status 62 to both Mask Definition segment 64 and Synchronization segment 70 while receiving Details of Mask Definition Outputs 58 from Mask Definition segment 64. Details of Mask Definition Outputs 58 also flow to Synchronization segment 70 as shown by arrow.

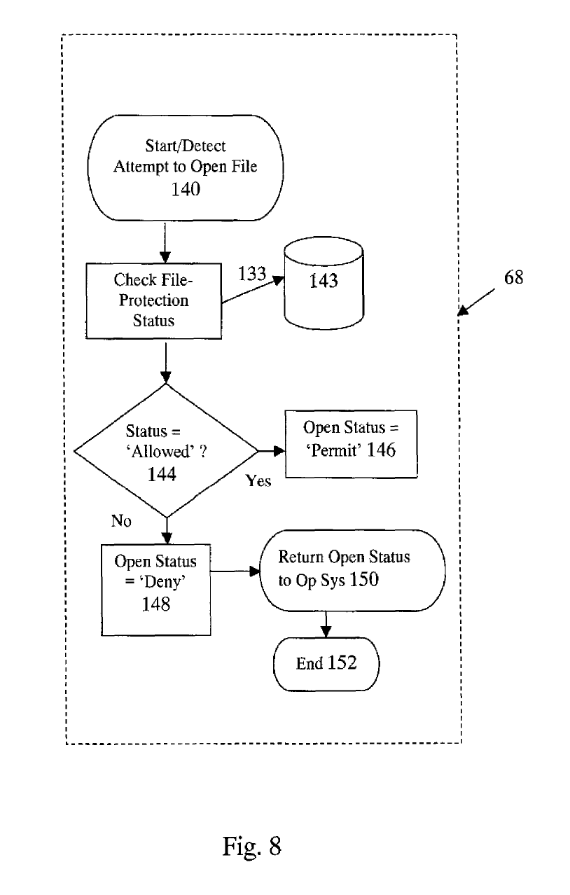

File Protection segment 68 does not interact directly with the other three segments which comprise Field Masking System 36, but rather indirectly (indicated by dashed arrow 72) via the computer's operating system. If an access attempt is blocked by File Protection segment 68 (as is described in reference to FIG. 8), then Synchronization segment 70 will not be executed for the access attempt in question.

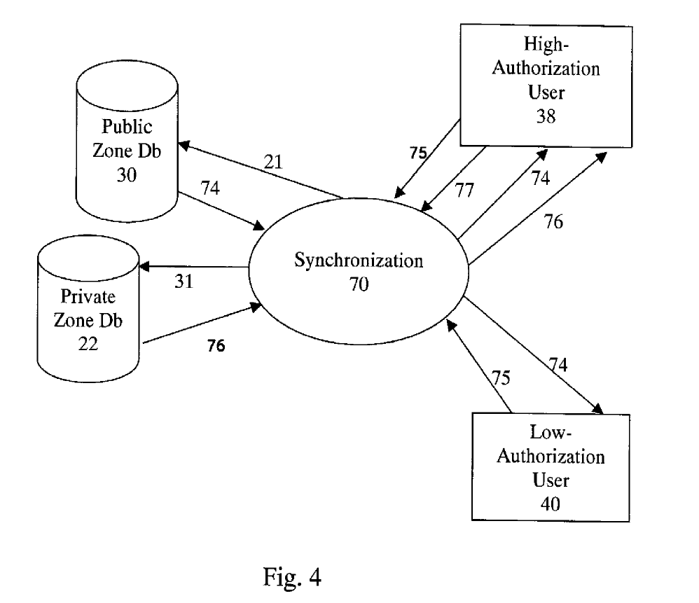

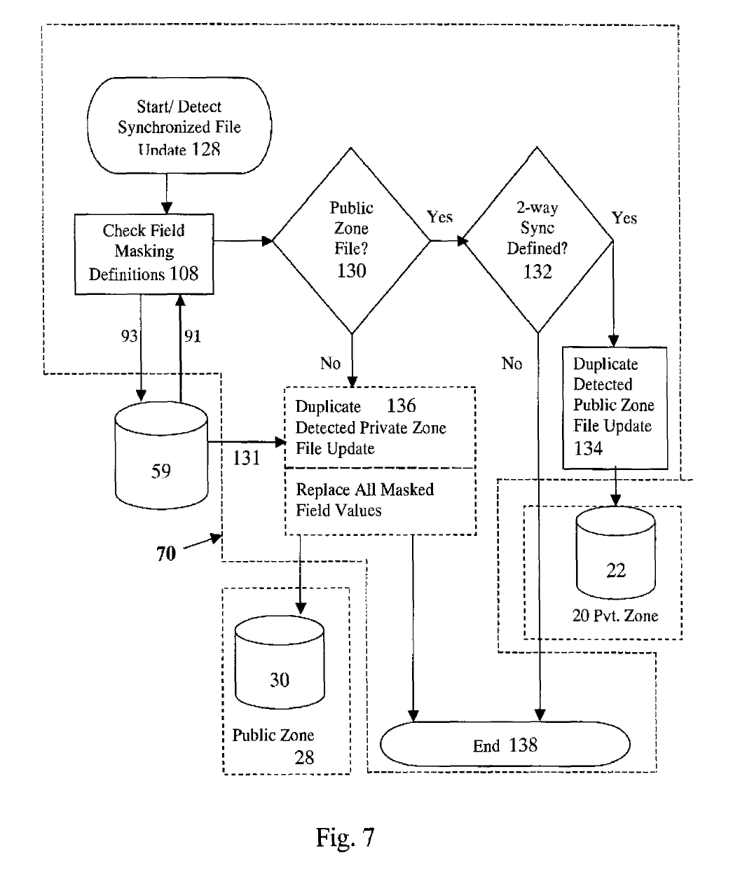

FIG. 4 is a data flow diagram showing in detail the data flow process of the Synchronization segment. The actions involved in the synchronization process are summarized hereinafter in respect to FIG. 7.

A Public Zone Db 30 provides public data 74 to Synchronization segment 70 and receives from it synchronized private data 21. A Private Zone Db 22 provides private data 76 to Synchronization segment 70 and receives synchronized public data 31.

A High-authorization user 38 is enabled to make both a public data request 75 and a private data request 77 from Synchronization segment 70, and receives both public data 74 and private data 76.

A Low-authorization user 40, on the other hand, may make a public data request 75 and receives public data 74, but cannot even make a private data request 77 due to the previously mentioned blocking activity of the File Protection segment 68 (see FIG. 3).

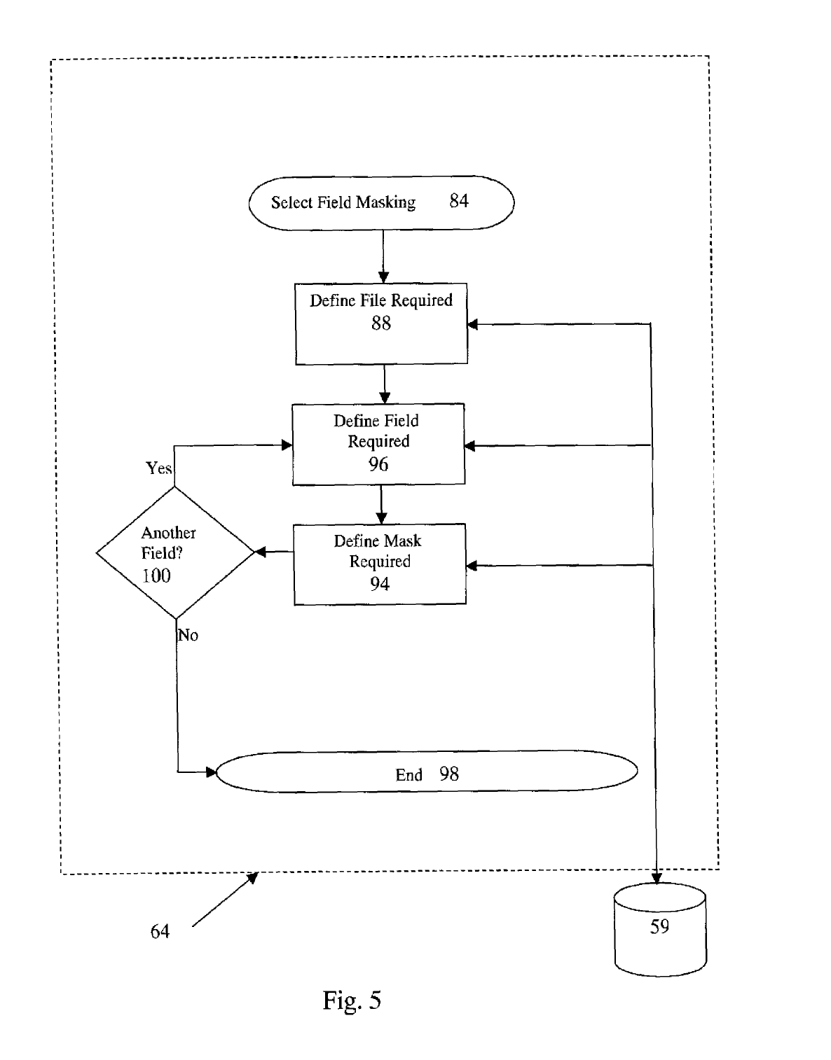

FIG. 5 is a flow chart showing the method of the process for the Mask Definition segment. A System Administrator 42 (see FIG. 2) manages Mask Definition segment 64 utilizing a user interface (not shown), to first enter, at the Select Field Masking block 84, the interactive set-up for Mask Definition segment 64. A file is selected and then defined for masking at the Define File Required block 88 in which selected file and library names, and the mode of synchronization are specified by the user, while interacting with Field Masking definitions Db 59, shown as external to Mask Definition segment 64. The synchronization (Sync) mode provided by the system is one of the following: No Sync, One-way Sync, and Two-way Sync, as explained below.

### No Synchronization

A masked file is created and placed in the designated masked file library. Changes to either the original file or the masked file are independent of each other. Fields defined as masked fields remain masked in the masked file at all times.

### One-way

A masked file is created and placed in the designated masked file library. Changes made in the original file will be reflected in the masked file, but changes made in the masked file do not affect the original file. Fields defined as masked fields remain masked in the masked file at all times.

### Two-way

A masked file is created and placed in the designated masked file library. Changes made in the original file are reflected in the masked file as described in the one-way mode above. Additionally, changes made in unmasked fields of the masked file are reflected in the original file. Changes in values of masked fields of the masked file do not affect the values in the original file.

Referring now again to FIG. 5, after defining a file required for masking—the masked file—a user proceeds to Define Field Required at block 96 where a field to be masked is selected by interacting with Field Masking definitions Db 59 through a user interface (not shown). Field Masking definitions Db 59 is external to Mask Definition segment 64. After selecting a field to be masked, the user proceeds to Define Mask Required at block 94 to assign a masking type by interacting with Field Masking definitions Db 59 through the user interface (not shown).

In a preferred embodiment of the present invention, a masking type is selected from the group comprising: high values, low values, encrypt, all 9's, all zeros, and blanks. Other masking types may be used, such as printing symbols (asterisks, ampersand sign, and the like), as are known to those skilled in the art. The specified field is added to the list of fields to be masked.

At step Another Field? at block 100, if the answer input to the system is “Yes”, and all the required fields have been selected and their mask types assigned, the operation is repeated for the other field or fields selected. If there are no more masked fields to be selected, or masks defined for each, i.e., the answer input to the system is “No”, the process terminates at End block 98. Additional files and fields can be added later or deleted from the list at any time using the user interface (not shown) for Mask Definition segment 64.

A typical example of a field chosen might be the salary field in an employee file. The masking selected might be ‘all 9s’ which would result in the field value being replaced by 9's in the masked file. Another example might be the name-field, which, optionally, is masked with the ‘encrypt’ mask type, which would result in the field value being replaced by an encrypted value in the masked file.

The user chooses the value required for a chosen field only for those fields selected to be masked from a particular file. This is the value that is placed into the masked file. The masking process is not implemented until the masked file is activated.

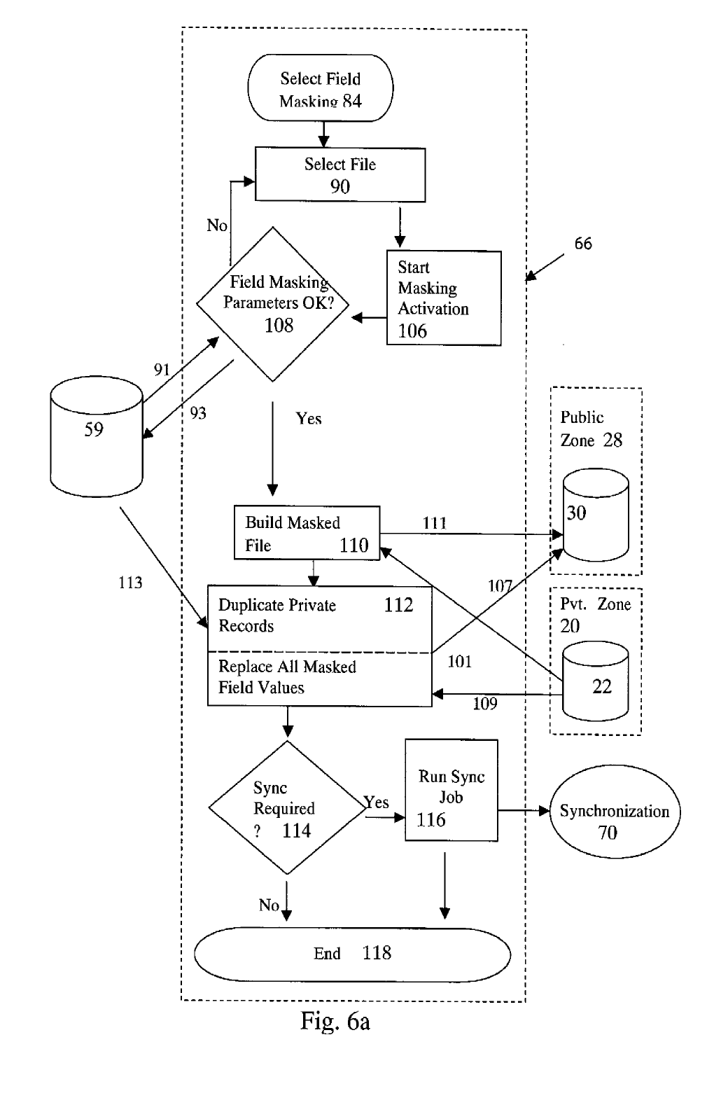

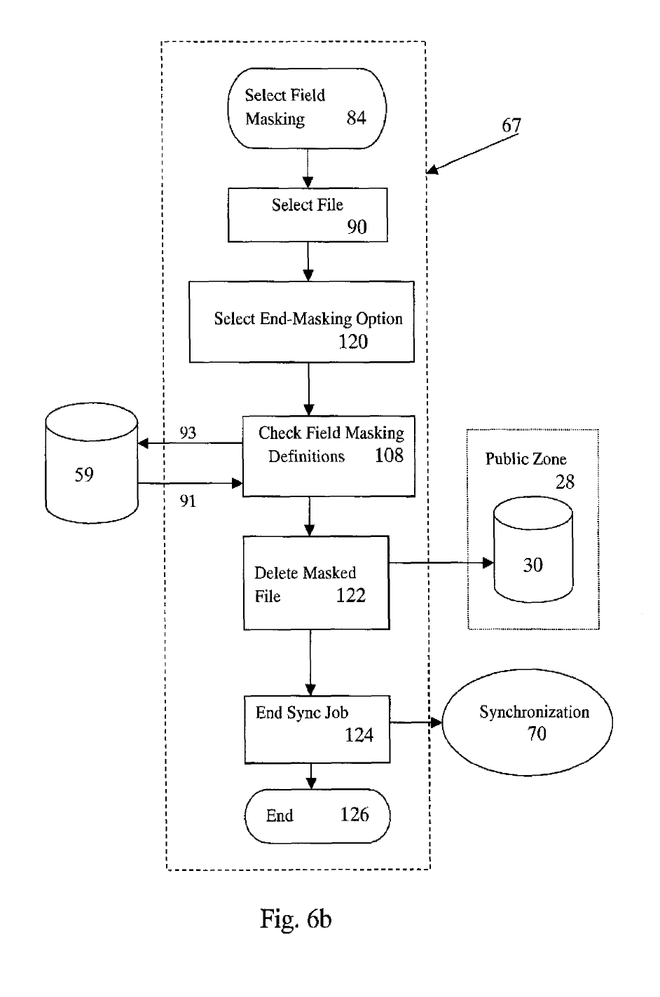

FIG. 6a is a flow chart showing the starting masking actions of the Activation method. A user enters Start Activation segment 66 through a user interface (not shown) and chooses Select Field Masking block 84. Next, a user chooses Select File block 90 which, in a preferred embodiment of the present invention, is chosen from a displayed list of files. Then a user initiates the masking process at Start Masking Activation block 106. A user has the option to choose to start immediately or at a later time by entering the relevant date and time through use of the user interface.

The following actions are then initiated by the system:

1. A system check—represented by arrows 91 and 93, from and to, respectively, Field Masking definitions Db 59—is made at Field Masking Parameters OK? at block 108 to determine if the file selected is eligible for masking. If the answer is “No”, the masking will not be started and the process returns the user to block 90. If eligible for masking, “Yes”, the process continues.
2. A masked file is created at Build Masked File at block 110 and saved to Db 30 in Public Zone 28 as shown by data flow arrow 111. Since the masked file is based on the creation of a duplicate file corresponding with an original, unmasked sensitive file in Db 22 in Private Zone 20, the system provides this data as shown by arrow 107.
3, The content of the masked file is duplicated from the original at Duplicate Private Records block 112 based on data communicated from Db 22 in Private Zone 20 as indicated by arrow 109, and while in communication with Field Masking definitions Db 59, as indicated by arrow 113, while simultaneously (indicated by broken line in block 112), the masked field values are reprocessed at Replace All Masked Field Values 112 and the masked data values are uploaded into Db 30 in Public Zone 28 as shown by arrow 101.
4. For a system using the IBM iSeries, for example, a job is initiated which will keep the original file and the masked file synchronized (“in sync”). As long as the job is “Active” (indicated by its status as reported on a user interface, not shown), the two files will be in sync, otherwise the file is shown as “Inactive”. Each record added, removed or changed in the original file is duplicated in the masked file, or vice versa. All fields retain their original value except those fields defined for masking as described above.
5. The Status field is changed from “Inactive” to, by way of example, a status selected from one of the following:

“Active”; Job name: BSFCNxxxxx (One-way or two-way synchronization);

“File Created DD/MM/YYYY HH:MM:SS” (No synchronization); and

“No File” (file has been deleted or cannot be created).

Referring further to FIG. 6a, if synchronization is required (“Yes”) as noted in query Sync Required? at block 114, a Run Sync job at block 116 is initiated and processed through Synchronization segment 70. If no synchronization is required (“No”), the process ends at End block 118.

FIG. 6b is a flow chart of the ending masking actions of the Activation method. It illustrates how to stop field masking for a selected file in the list. A user enters the End Activation segment 67 at the Select Field Masking block 84 and selects the required file from a user interface (not shown) at the Select File block 90. From this user interface, at the Select End-masking Option block 120, a user identifies the file name, library name, and type of ending which, optionally, is either “now” or “at a later time”. If later, the relevant date and time are specified by the user.

At Check Field-masking Definitions block 108, the system interacts with Field Masking definitions Db 59, as shown by arrows 91 and 93, to activate the following process:

1. The masked file is deleted from the masked file library at Delete Masked File block 122 in communication with Db 30 in Public Zone 28.

2. In the case of files in an IBM operating system, as mentioned above, the iSeries job previously initiated to keep the original file and a corresponding masked file synchronized is ended at End Sync Job block 124.

3. The Status field is changed from “Active” to “Inactive” in the Synchronization segment 70 and the masking process ends at End block 126 until restarted by a user. FIG. 7 is a flow chart of the method of synchronization. Synchronization is facilitated by the system automatically creating at least one duplicate masked file for each corresponding original file defined for masking. An unauthorized user is then given access only to the at least one duplicate masked file, while access to the respective original file is strictly controlled. The corresponding masked file has selected fields masked from view. The method of the present invention in relation to synchronization ensures that the at least one masked file and its corresponding original are always synchronized. The software monitors all synchronized file update operations in the system and determines if the files involved are defined in the Field Masking System 36 (see FIG. 2). If so, the updates are made in the original file, or the corresponding masked file, depending on the particular definitions made.

### Synchronization—Private Zone to Public Zone

Synchronization of changes made from the at least one original (Private Zone) file to the corresponding masked (Public Zone) file are summarized as follows:

(1) new records in the at least one original file are added to the corresponding masked file for those fields defined as masked fields which are given the values defined in the predefined mask definition;
(2) changed records in the at least one original file are changed in the corresponding masked file with the same field values, except fields defined as masked fields which are given the values defined in the pre-defined mask definition; and
(3) deleted records in the at least one original file are deleted in the corresponding masked file.

### Synchronization—Public Zone to Private Zone

Synchronization of changes made from the at least one masked (Public Zone) file to the corresponding, original (Private Zone) file are summarized as follows:

(1) new records in the at least one masked file are added to the corresponding original file with the same field values;
(2) changed records in the at least one masked file are changed in the corresponding original file with the same field values, except fields defined as masked fields, which are unchanged; and
(3) deleted records in the at least one masked file are deleted in the corresponding original file.

Referring now in detail to FIG. 7, Synchronization process segment 70 is shown demarked by dashed lines. It is an internal program of the system beginning at the Start/Detect Synchronized File Update block 128 and is automatically initiated as part of the system of the invention. At the Check Field-masking Definitions block 108, the system communicates with (as indicated by arrows 91 and 93) and searches Field Masking definitions Db 59 for mask definition details. If it is determined that the file update attempt at Start/Detect Synchronized File Update at block 128 is for a Public Zone file (“Yes”) in response to query, Public Zone file? at block 130, then the process further verifies whether 2-Way Sync Defined? at block 132 and in response to the query, determines whether synchronization is required (“Yes”). If “No”, the system ends at End block 138.

A two-way sync defines a Public Zone file update which, in the case of a positive response by a user, is then duplicated to Db 22 in Private Zone 20 via the Duplicate Detected Public Zone File Update block 134. If the defined file is not a Public Zone file (“No”) in response to query at block 130, it is certainly a Private Zone file, so the updated file is duplicated at Duplicate Detected Private Zone File Update block 136 and stored in Db 30 in Public Zone 28. The updated duplicated file—a copy of the corresponding, unmasked, original file update—has masked values in sensitive fields and the system automatically performs the step Replace All Masked Field Values at block 136 simultaneously (indicated by dashed line in block 136) as part of the duplication process for the update in accordance with masking definitions communicated from Field Masking definitions Db 59, as indicated by arrow 131. The process is completed for the updated file in question at End block 138.

FIG. 8 is a flow chart of the method of the File Protection process segment. The method for File Protection relies on predefining one or more files as ‘protected files’ and saving their file names and locations in a File Protection definitions Db 143. A list of files known to the system is maintained in a system policy section having two purposes. First, the system policy section defines all files for protection by the system and, secondly, it applies a default permission status to all users in the system, both individuals and groups, who have not been assigned specific permissions. The required access permissions are also stored in the File Protection definitions Db 143 along with the file-protection status of the respective files.

The file-protection status for protected (hereinafter referred to as masked) files are defined as “permit” when access is allowed and “deny” when access is not allowed. Attempts to open the masked files are detected automatically by the system utilizing a File Protection means which checks the File Protection Db for the required access permissions and the file protection status of the masked file associated with an Open File attempt. The File Protection means allows access to the masked files when the status is “Permit” and denies access when the status is “Deny”.

For a selected user, IP address or group of users, a system administrator 42 (see FIG. 2) administers the level of file protection from a menu in a user interface (not shown). The File Protection process segment 68 allows a System Administrator 42 to control access to masked files over and above the access control provided by the computer operating system in which it is applied. It provides an additional layer of protection to that afforded by the operating system, but does not replace it.

Referring further to FIG. 8, the method operates autonomously once activated in the Start/Detect Attempt to Open File block 140, when a user seeks to open a file within the system. An alert is initiated in Check File-protection Status block 142, which searches the status of the file in question and the user's level of authorization, high or low, by communicating with (indicated by arrow 133) File Protection definitions Db 143. File Protection definitions Db 143 stores file status data, records of users previously defined for file protection in the system policy—as explained above—and libraries associated with those files. If no unauthorized files/users are marked, then access is allowed to all items listed.

The Status=“Allowed” block 144 points either to a decision, “No”, to deny access at the Open status=“Deny” block 148 or to enable access, if “Yes”, at the Open status=“Permit” block 146. In either case, the system then proceeds to Retun Open status to Op Sys (Operating System) at block 150, ending the File Protection process segment at End block 152.

Having described the present invention with regard to certain specific embodiments thereof, it is to be understood that the description is not meant as a limitation, since further modifications may now suggest themselves to those skilled in the art, and it is intended to cover such modifications as fall within the scope of the appended claims.

I claim:

1. A system for masking at least one, selected field in at least one, original database (Db) file, said system comprising:
a) a Mask Definition means for defining said at least one, selected field for activation of masking;
b) an Activation means for implementing said masking by creating at least one duplicate file of a corresponding one of said at least one, original Db file, and masking said at least one, selected field therein; and
c) a Synchronization means for synchronizing data between said at least one, original Db file and a corresponding one of said at least one duplicate file,
such that when a user has defined said at least one, selected field for masking utilizing said Mask Definition means, and has implemented said masking utilizing said Activation means, said Synchronization means synchronizes data between said at least one duplicate file and a corresponding one of said original Db file.

2. The system as claimed in claim 1 wherein said system further comprises a File Protection means for controlling access to said at least one, original Db file at the highest levels of information security.

3. The system as claimed in claim 1 wherein said Mask Definition means comprises a Mask Definition segment,
wherein, when said at least one selected field is masked utilizing at least one mask to apply to each of said at least one, original database (Db) file, said at least one mask being selected from a masking algorithm group comprising: high values, low values, encrypted, all 9's, all zeros, and blanks; said Mask Definition means stores said masked files in a field masking definitions Db.

4. The system as claimed in claim 1 wherein said Activation means comprises an Activation segment,
wherein, when said Activation segment is operated, said at least one duplicate file is created having all required fields masked as defined by said Mask Definition means and the activation status of said at least one duplicate file is concurrently changed.

5. The system as claimed in claim 1 wherein said Synchronization means comprises a Synchronization segment,
wherein, when synchronization is defined as two-way and activated, changes are made in said at least one, original file to reflect changes made in a corresponding one of said at least one, duplicate file, by applying rules from said Mask Definition means.

6. The system as claimed in claim 1 wherein said Synchronization means comprises a Synchronization segment,
wherein, when synchronization is defined as one-way or two-way and activated, changes are made in said at least one, duplicate file to reflect changes made in said corresponding one of said at least one, original Db file, by applying rules from said Mask Definition means.

7. The system as claimed in claim 2 wherein said File Protection means comprises a File Protection segment,
wherein, when said File Protection segment detects an open file attempt on a protected file, said protected file is checked for file-protection status against predefined parameters stored in a file protection definitions Db, and if status is ‘allowed’, permits said file to be opened; and if said status is ‘deny’, denies said open file attempt.

8. A method for masking at least one, selected field in at least one, original Db file, said method comprising:
a) defining said at least one, selected field for activation of masking;
b) implementing said masking by creating at least one duplicate file of a corresponding one of said at least one, original Db file, and masking said at least one, selected field therein; and
c) synchronizing data between said at least one, original Db file and a corresponding one of said at least one duplicate file,
such that when a user applies a definition from step a) to said at least one, selected field and has implemented said masking, said data is synchronized between said at least one duplicate file and a corresponding one of said at least one, original Db file.

9. The method of claim 8 further comprising:
d) controlling access to said at least one, original Db file at the highest levels of information security.

10. The method of claim 8 wherein said definition comprises the steps of:
selecting a Field Masking System;
selecting a file to be defined as a masked file;
selecting at least one field from said selected file for masking;
selecting at least one mask to apply to said at least one selected field; and
storing said mask definition in a field masking definitions Db.

11. The method of claim 10 wherein said Field Masking System comprises:
a) a Mask Definition means for defining said at least one, selected field for activation of masking;
b) an Activation means for implementing said masking by creating at least one duplicate file of a corresponding one of said at least one, original Db file, and masking said at least one, selected field therein; and
c) a Synchronization means for synchronizing data between said at least one, original Db file and a corresponding one of said at least one duplicate file,
such that when a user has defined said at least one, selected field for masking utilizing said Mask Definition means, and has implemented said masking utilizing said Activation means, said Synchronization means synchronizes data between said at least one duplicate file and a corresponding one of said original Db file.

12. The method of claim 11 further comprising a File Protection means for controlling access to said at least one, original Db file at the highest levels of information security.

13. The method of claim 12 wherein said File Protection means comprises:
defining which files are to be considered ‘protected files’;
saving the file names and locations in a file protection definitions Db;
assigning required access permissions to each of said masked files for different levels of users;
detecting an Open File attempt;
checking file-protection status against predefined parameters stored in said file protection definitions Db; and
allowing access to said masked file when said required access permissions is an “Allow” status, and denying access to said masked file when said required access permissions is a “Deny” status.

14. The method of claim 13 wherein said required access permissions is applied by default to all users including both individuals and groups who have not been assigned specific said access permissions.

15. The method of claim 10 wherein said at least one mask is selected from a masking algorithm group comprising: high values, low values, encrypted, all 9's, all zeros, and blanks.

16. The method of claim 11 wherein said activation comprises the steps of:
duplicating at least one, original Db file to make at least one duplicate file;
masking all required fields in said at least one duplicate file;
changing Activation Status of said at least one duplicate file; and
initiating a background synchronization between one of said at least one, original Db file and a corresponding one of said duplicate file.

17. The method of claim 16 wherein said background synchronization between said at least one, original Db file with said at least one duplicate file is activated when said synchronization is defined as one-way or two-way so that changes made in said at least one, original Db file are reflected in a corresponding one of said at least one, duplicate file, by applying rules from said mask definition.

18. The method of claim 16 wherein said background synchronization between said at least one, duplicate file with a corresponding original Db file is activated when said synchronization is defined as two-way so that changes made in said at least one duplicate file are reflected in said corresponding one of said at least one, original Db file, by applying rules from said mask definition.

19. The method for mask definition of claim 11 further comprising:
d) deactivating said mask definition.

20. The method of claim 19 wherein said mask definition deactivation comprises:
deleting said at least one duplicate file;
changing said Activation Status; and
ending said background synchronization.
